(19) United States
(12) Patent Application Publication
(10) Pub. No.: US 2022/0232752 A1
(43) Pub. Date: Jul. 28, 2022

(54) AGRICULTURAL WORK MACHINE AND OPERATING DEVICE

(71) Applicant: CLAAS Tractor SAS, VéIizy-Villacoublay Cedex (FR)

(72) Inventors: Rémi Garcia, Fontenay-Aux-Roses (FR); Fabien Roger, Paris (FR); Jérémy Renaud, Bourg Achard (FR); Pierre Bourry, Le Mans (FR)

(73) Assignee: CLAAS Tractor SAS, VéIizy-Villacoublay Cedex (FR)

(21) Appl. No.: 17/583,639

(22) Filed: Jan. 25, 2022

(30) Foreign Application Priority Data
Jan. 26, 2021 (DE) 102021101670.3

(51) Int. Cl. A01B 71/02; A01B 59/04; B60K 37/06

(52) U.S. Cl. CPC A01B 71/02; A01B 59/04; B60K 2370/11; B60K 2370/126; B60K 2370/162; B60K 37/06

(57) ABSTRACT

An agricultural work machine and an operating device for controlling the operation of both of a front lifting mechanism and a rear lifting mechanism of an agricultural work machine are disclosed. The agricultural work machine includes a front lifting mechanism, a rear lifting mechanism, and an operating device. The operating device includes an operating element configured to control operation of the front lifting mechanism and the rear lifting mechanism, at least one visualization element, and at least one selection switch. The at least one selection switch is configured to receive a selection of at least one of the front lifting mechanisms or rear lifting mechanism for active control; and the at least one visualization element is configured to visually indicate a current lifting position of the one of the front lifting mechanism or the rear lifting mechanism selected for active control.

### CROSS REFERENCE TO RELATED APPLICATION

This application claims priority under 35 U.S.C. § 119 to German Patent Application No. DE 102021101670.3 filed Jan. 26, 2021, the entire disclosure of which is hereby incorporated by reference herein.

### TECHNICAL FIELD

The present invention relates to an agricultural work machine and an operating device.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

An agricultural work machine may be configured to be used as a prime mover of agricultural machines or attachments for the agricultural cultivation of fields. To accomplish this, the attachment is connected to the agricultural work machine, for example, by using a coupling. A baler is an example of an attachment.

The agricultural work machine may include one or more lifting mechanisms (e.g., a front lifting mechanism and/or a rear lifting mechanism) and an operating device. One example of an agricultural work machine may comprise a tractor.

A lifting mechanism frequently used is a “three-point power lifter” or “three-point hydraulic system”, which is a hydraulic apparatus on the tractor configured to couple or lift an attachment. The term “three-point” stems from the fact that the device is normally attached to the tractor by three attachment points. Further, the downward movement of the lifting mechanism may be achieved by its own weight or by the weight of the attachment. Otherwise, the lifting mechanism may be hydraulically operated.

German Patent Application No. DE 102006046646 A1, incorporated by reference herein in its entirety, discloses a display unit with display fields for visualizing vehicle information for use in vehicles with a pivotable driver's seat or driver's cab. By pivoting the driver's seat or the driver's cab, the display fields on the display unit change, taking into account the particular position of the driver's seat or the driver's cab. This ensures that, despite the pivoting of the driver's seat or the driver's cab, the driver's perception or orientation toward the display is not altered. In other words, the driver may be able to operate the machine with ease and thereby reduce errors.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates a schematic side view of an agricultural work machine according to the invention;

FIG. 2 illustrates a schematic perspective view from the front and right: a light strip corresponding to the left;

FIG. 3 illustrates a schematic perspective view from the rear and right: a light strip corresponding to the left; and

FIG. 4 illustrates a schematic detail view of an operating device according to the invention.

### DETAILED DESCRIPTION

Modern agricultural work machines may be equipped with various technology. In this regard, it may be advantageous to integrate control devices or display devices for controlling or monitoring the technology in the driver's work area. In particular, with modern agricultural work machines, the driver may simultaneously view several display units or operating devices, such as disclosed in DE 102006046646 A1, in order to operate and drive the agricultural work machine. This holds true when the attachment expands the agricultural work machine in size. In this case, the driver monitors both the agricultural work machine and the attachment using the display unit(s) or operating devices. This may be very challenging for the driver and may requires a high degree of attention and concentration. Accordingly, in one or some embodiments, a system is disclosed that assists the driver to operate the agricultural work machine.

In this regard, in one or some embodiments, an agricultural work machine is disclosed that includes a front lifting mechanism, a rear lifting mechanism, and an operating device for controlling the operation of both the front lifting mechanism and the rear lifting mechanism of an agricultural work machine.

The operating device includes an operating element configured to control the operation of the front lifting mechanism and the rear lifting mechanism, at least one visualization element, and at least one selection switch. Further, the at least one selection switch is configured to receive a selection of at least one of the front lifting mechanism or rear lifting mechanism for active control; and the at least one visualization element is configured to visually indicate a current lifting position of the one of the front lifting mechanism or the rear lifting mechanism selected for active control. As discussed in more detail below, the at least one selection switch may be manifested in one or more ways. Alternatively, or in addition, the at least one visualization element may likewise be manifested in one or more ways.

In this way, the agricultural work machine (also termed a work machine) may be operated easily through the operating device. Specifically, the operating device includes the at least one selection switch through which the driver may select which of the lifting mechanisms to operate or control. The driver may actuate the selection switch and therefore select whether to operate the front lifting mechanism or the rear lifting mechanism.

In one or some embodiments, the at least one selection switch comprises two pushbuttons that may be alternatively activated (e.g., pressed), with each one of the pushbuttons being assigned to a respective one of the front lifting mechanism or rear lifting mechanism. The pushbuttons may include visual feedback means through which the machine driver may be notified which pushbutton is currently switched to “active”, and therefore which of the front lifting mechanism or the rear lifting mechanism is currently being controlled. As discussed further below, the pushbutton(s) may comprise mechanical button(s) and/or virtual button(s) (e.g., icons on a touchscreen display).

In one particular example, the operating element may comprise a rotary switch, such as an incremental rotary switch or continuous rotary switch. Specifically, the rotary switch may particularly be robust in use in an agricultural context. When operating the agricultural work machine, normally soiling such as dust or dirt is unavoidable. In such a dirty milieu, the rotary switch may be very reliably used. Moreover, the rotary switch may be operated very intuitively due to its well-known mode of operation (e.g., by rotation).

In one or some embodiments, the rotary switch may comprise a rotary pushbutton switch that, in addition to the functionality of a pure rotary switch, may also have the function of a pushbutton switch, such as a pushbutton. In this way, in one embodiment, the operating element and the selection switch may be combined into one component, wherein accordingly, the operating element may be formed by the rotary switch, and the selection switch may be formed by the pushbutton switch. In this regard, a single device may perform the functions of both the operating element (e.g., responsive to receiving a rotary input indicative of an amount of lifting of the lifting mechanism selected for active control, controlling the activated lifting mechanism to the requested amount of lifting) and the selection switch (in terms of selecting which of the front lifting mechanism or rear lifting mechanism to activate). When designing the pushbutton switch as a pushbutton, the focus of the operating element may, for example, be switched from one to the other lifting mechanism with each actuation. In this context, it may be advantageous to save a current lifting position of the currently active lifting mechanism by pressing the rotary pushbutton switch. Alternatively, or in addition, it is also contemplated that, by pressing the rotary pushbutton switch, an already-saved lifting position is selected or retrieved and, depending thereupon, the active lifting mechanism is controlled into this already-saved lifting position. Moreover, an assignment of the rotary pushbutton switch with several pressing modes may also be provided. The rotary pushbutton switch may, for example, be operated by being pressed once, or twice, or repeatedly.

So that the driver does not become confused during operation as to which of the lifting mechanisms she/he has just selected by the selection switch and is therefore operating, the operating device may further include the at least one visualization element. Using the at least one visualization element, the driver may receive visual feedback of a current lifting position of the active lifting mechanism on which the operating element is currently controlling.

Various visualization element(s) are contemplated. In one or some embodiments, the visualization element may, for example, be designed in the form of a visual display (e.g., a touchscreen display with one or more icons indicative of the lifting mechanism subject to active control and/or the current lifting position of the active lifting mechanism and/or the target lifting position of the active lifting mechanism to indicate the operator's desired position for the active lifting mechanism).

In one or some embodiments, the visualization element includes a light strip through which the current lifting position of each active lifting mechanism may be displayed. In particular, the light strip may visualize an entire working range thereof located between opposite end positions of the active lifting mechanism (e.g., fully lifted position (or upper end position) to fully lowered position (or lower end position)) divided into a plurality of discrete position steps. The lifting mechanism subject to active control may be adjusted, such as smoothly, between an upper end position (e.g., which may be termed a street operating position in which the lifting mechanism is lifted essentially to a maximum to protect same) and a lower end position (e.g., which may be termed a working position in which the lifting mechanism is lowered essentially to a maximum for coupling the attachment). The light strip accordingly may characterize the current lifting position of the lifting mechanism subject to active control. In other words, the light strip may indicate the lifting position in which the particular active lifting mechanism is currently located. This yields the advantage that the driver may visually identify the current lifting position of the lifting mechanisms very clearly and easily. This may specifically be enabled by the plurality of position steps, or sections of the light strip since the driver may very easily and precisely estimate a scale of the light strip as being correlated to a current lift position.

Moreover, in one or some embodiments, the visualization element may include a plurality of bar-like or circular-arc-like lighting sections as adjacently arranged lighting means, wherein each lighting means (e.g., an LED light or the like) may correspond to a position step of the active lifting mechanism. It is contemplated for the lighting means to be arranged or oriented relative to each other such that an entire working range of the lifting mechanisms is depicted by a totality of the lighting means. In other words, the lighting means may be arranged corresponding to a path that can be realized by the lifting mechanisms. This yields the advantage that the current lifting position of the particular lifting mechanism is very easily recognizable.

In one or some embodiments, the visualization element comprises a continuous screen (e.g., a display), such as a liquid crystal display (LCD). In a specific embodiment, a single display is used in order to generate the visualization element on a graphical user interface (GUI) for display, with the visualization element not being divided into individual components. Alternatively, or in addition, the screen may comprise a touchscreen display that displays icon(s) (e.g., a front lifting mechanism icon corresponding to the front lifting mechanism and a rear lifting mechanism icon corresponding to the rear lifting mechanism) with activation of a respective icon on the touchscreen corresponding to a request to the operating device to activate the lifting mechanism correlated to the icon (e.g., touching of the front lifting mechanism icon corresponds to a request to the operating device to actively control the front lifting mechanism). Alternatively, or in addition, the means through which to input the target lifting position may be via the display (e.g., an input via the touchscreen).

Moreover, in one or some embodiments, the visualization element may include a numeric reproduction to reproduce numeric values, such as numbers indicative of percentages or angles. For certain applications, for example to couple the attachment, it may be necessary to position the lifting mechanism very precisely. In certain instances, the light strip may provide an approximate indication of the lifting position, which may be insufficient. Thus, in one instance, the driver may input a specific numerical value or a specific percentage to precisely and reproducibly orient the lifting mechanism (e.g., via the touchscreen).

With the visual feedback provided, the driver may easily only focus on the currently controlled operating device. Further, due to the reduced complexity of the visual feedback, errors in operation may be reduced since the concentration of the driver may be focused on the currently controlled operating device.

Thus, in one or some embodiments, the visualization element may visually display a current selection of one of the lifting mechanisms for operation using the operating element, such as via a change in color of at least one multi-color lighting means. In one or some embodiments, each of the lifting mechanisms may be assigned an individual color. In this way, the color of the lighting means itself may be perceptible via a peripheral glance of the driver. The driver therefore need not direct her/his attention to the lighting means in order to determine which lifting mechanism is selected for active control. Thus, the driver may effortlessly see which lifting mechanism is selected for operation.

Moreover, in one or some embodiments, the agricultural work machine includes at least one memory unit through which the at least one piece of position information relating to a lifting position of at least one of the lifting mechanisms may be or is saved. The ability to save the position information has several advantages. First, when switching to one of the lifting mechanisms, the operating device makes it possible to indicate by the visualization element position information that the position of the respective lifting mechanism had at the time of last switching to the other lifting mechanism. In this way, the visualization element may reproduce the current lifting position of the lifting mechanisms. Second, saving position information may have the advantage that the machine driver intermediately stores certain lifting positions in order to automatically access them at a later time. In particular when coupling attachments, it may be necessary to very precisely align the lifting mechanism depending on the attachment. using the memory unit, the position information may be saved that, for example, corresponds to the particular attachment. When coupling, the required lifting position of the particular lifting mechanism may therefore be directly achieved. Advantageously, this results in particularly fast and efficient operation.

Moreover, in one or some embodiments, at least one piece of range information relating to a work range of at least one of the lifting mechanisms may be or is saved on the memory unit. It is, for example, contemplated for the lifting mechanism to be loadable in the different positions. Such range information may, for example, be realized by a lower limit or an upper limit. It is therefore advantageous to be able to save certain range information in order to be able to ensure very safe operation.

In one or some embodiments, the operating device has a physical architecture that comprises (or consists of) three pieces of information. First, the lifting mechanism may be selected (e.g., exclusively either the front lifting mechanism or the rear lifting mechanism). Second, the position of the particular selected lifting mechanism may be selected, for example using a rotary pushbutton switch (as discussed above). Third, a position that has already been saved in the memory may be selected using the rotary pushbutton switch (e.g., responsive to activation of the rotary pushbutton switch, the operating device accesses from the memory storing the saved position and controls the currently active lifting mechanism to move the saved position). In this context, it may also be advantageous to compare a target position with the current position (e.g., the operating device may compare an operator-requested target lift position with the current lift position to determine a difference, and may optionally output via a display or the like the difference to the operator).

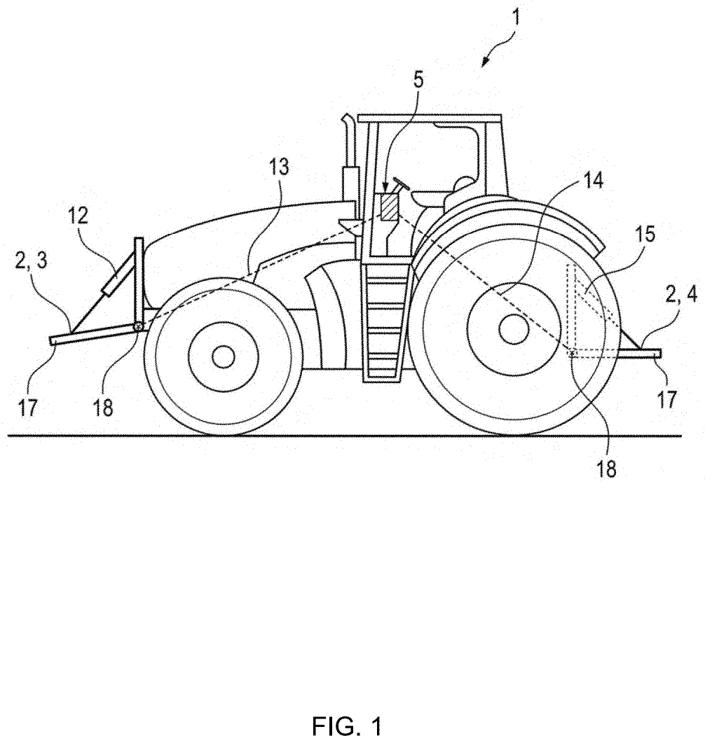

Referring to the figures, FIG. 1 discloses an agricultural work machine 1 that includes an operating device 5. In one or some embodiments, the agricultural work machine 1 (also termed a work machine) comprises a tractor. The agricultural work machine 1 is configured to couple an attachment (e.g., a baler or a chaff cutter), through which a field may be agriculturally processed. The attachment is not shown for reasons of clarity.

Depending on the type of attachment, the attachment is either coupled at the front or rear to the agricultural work machine 1. It is also contemplated for two attachments to be simultaneously coupled, one in the front and one in the rear. To this end, the agricultural work machine 1 comprises two lifting mechanisms 2 (e.g., a front lifting mechanism 3 in the front and a rear lifting mechanism 4 in the rear). The attachment may be connected by a coupling to the front lifting mechanism 3, or to the rear lifting mechanism 4. This allows for the attachment to be pushed or pulled by the agricultural work machine 1.

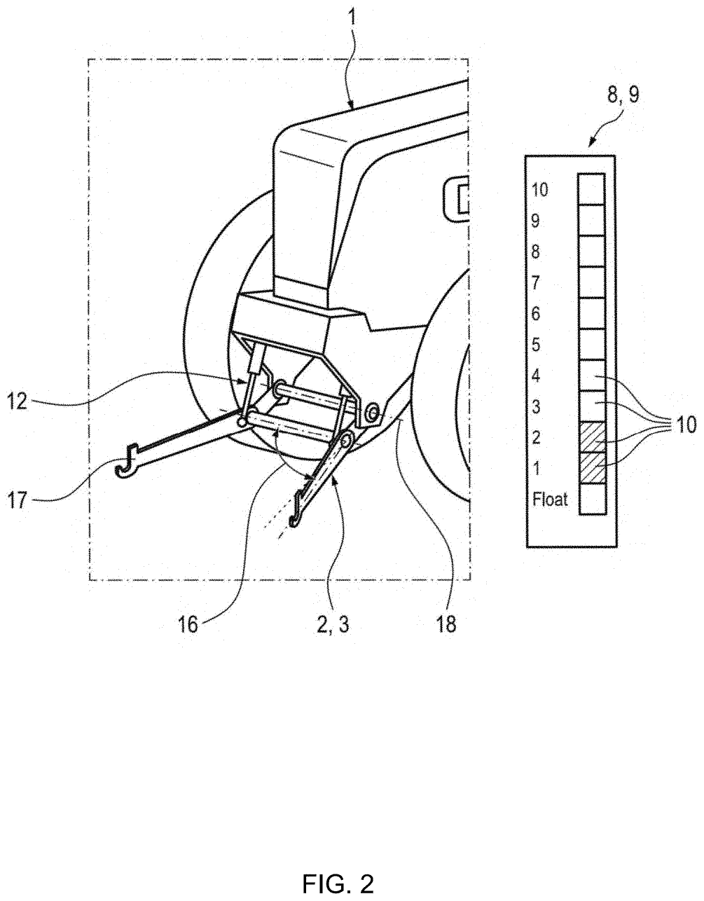

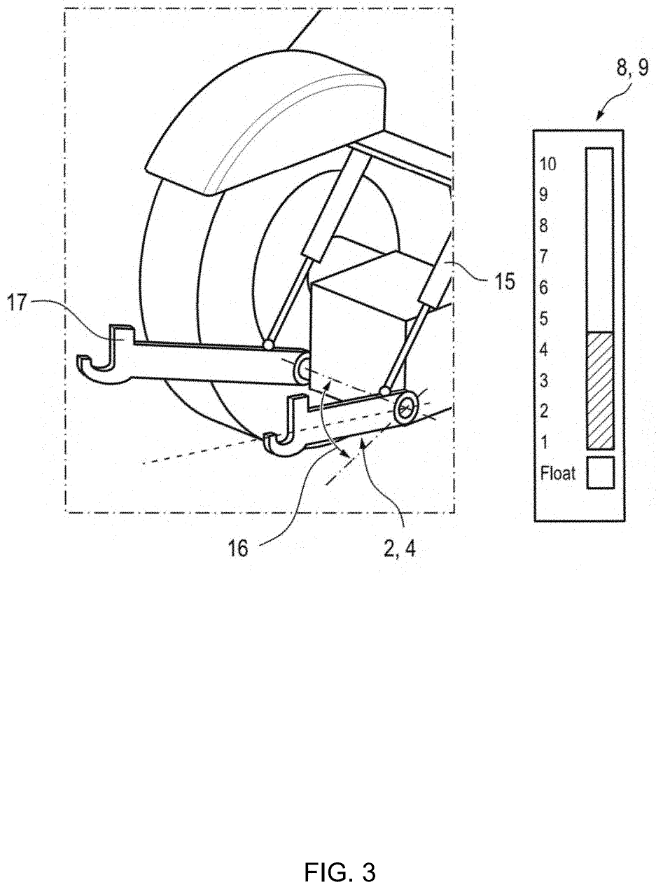

The front lifting mechanism 3 is shown in FIG. 2, and the rear lifting mechanism 4 is shown in FIG. 3. The lifting mechanisms 2 each comprise a cantilever arm 17 that is pivotably mounted about an axis 18. The lifting mechanisms 2 may normally be fixedly connected to a body of the agricultural work machine 1. Moreover, the lifting mechanisms 2 may each have a hydraulic device 12, 15 that is connected to the particular cantilever arm 17, and through which the cantilever arm 17 may be pivoted about the axis 18.

As shown in FIG. 2 and FIG. 3, the cantilever arm 17 may be pivoted within a working range 16. In other words, the cantilever arm 17 may be pivoted between a bottom end position and a top end position. In the present case, FIG. 2 and FIG. 3 each show an intermediate position that is closer to the bottom end position than to the top end position. Normally, the attachment may be coupled in this intermediate position.

During operation, the driver may seek to monitor and operate both the agricultural work machine 1 and any coupled attachment. To this end, the agricultural work machine 1 comprises an operating device 5, through which the driver may operate the lifting mechanisms 2. In the present case, a datalink 13, 14 (e.g., wired and or wireless) may be present between the lifting mechanisms 2 and the operating device 5. For example, the front lifting mechanism 3 may be connected via the datalink 13, and the rear lifting mechanism 4 may be connected via the datalink 14 to the operating device 5. As illustrated in FIG. 1, the datalink 13, 14 may be a wireless datalink. Alternatively, or in addition, the datalink 13, 14 may be a wired datalink.

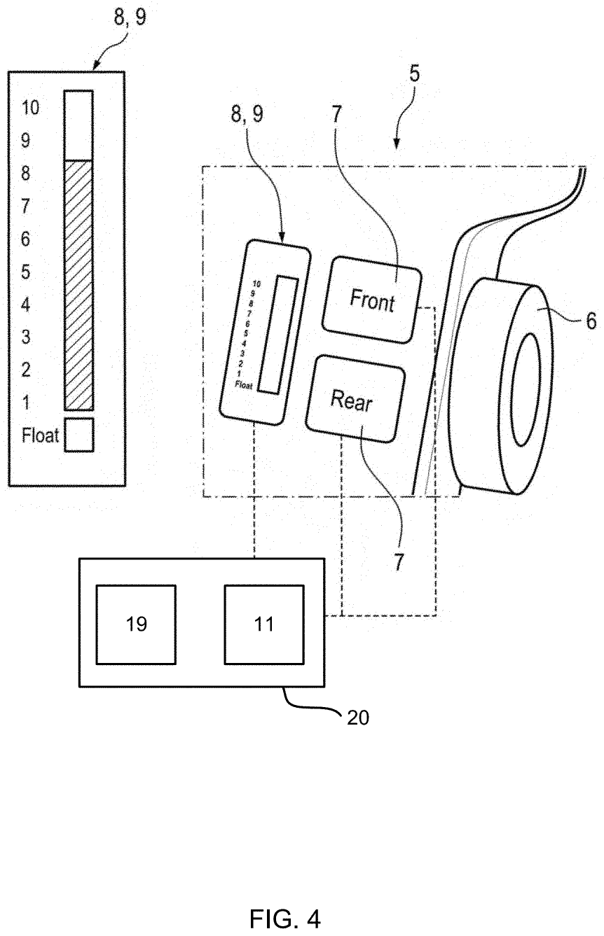

FIG. 4 shows the operating device 5. The operating device 5 may include two selection switches 7 (e.g., mechanical switches), through which either the front lifting mechanism 3 or the rear lifting mechanism 4 may be selected for active control. For instance, one selection switch may comprise a front lifting mechanism selection switch configured for selection of the front lifting mechanism for active control and a rear lifting mechanism selection switch configured for selection of the rear lifting mechanism for active control. A current selection may be visualized by the visualization element 8. In the present case, the visualization element 8 comprises a light strip 9, wherein may include a plurality of lighting means 10, as FIG. 2 shows on the right. In this case, the lighting means 10 may be arranged or oriented superimposed in the longitudinal direction of the light strip 9.

The light strip 9, using the individual lighting means 10, may characterize or display the position in which the cantilever arm 17 is located or arranged within the working range 16. In so doing, the lighting means 10 may increase in brightness as the cantilever arm 17 is pivoted in the direction of its top end position. In other words, a number of shining lighting means 10 on the light strip 9 may indicate to the driver the lifting position in which the particular lifting mechanism 2 is currently located or arranged.

In one or some embodiments, FIG. 4 may comprise a touchscreen display that may output icon(s) on a graphical user interface (GUI) (e.g., a front lifting mechanism icon indicative of selecting front lifting mechanism 3 and the rear lifting mechanism icon indicative of selecting rear lifting mechanism 4). Additionally, a current selection may be visualized by the visualization element 8 on a different section of a GUI. Further, a light strip present on the GUI may also characterize or display the position in which the cantilever arm 17 is located or arranged within the working range 16, on a GUI or a different section of a GUI. In one or some embodiments, the light strip present on the GUI may comprise a defined section of the GUI and need not include separate lights sources.

Moreover, the operating device 5 includes an operating element 6 that is depicted in FIG. 4 as a rotary switch. By rotating the operating element 6, for example, the driver may indicate a change in position of the lifting mechanism 2. In other words, the driver rotating the operating element 6 indicates to the operating device 5 to send a command to the lifting mechanism 2 to lower or rise. Further, by the driver rotating the operating element 6, the cantilever arm 17 may correspondingly pivot about the axis 18. In one or some embodiments, the operating element depicted in FIG. 4 may be located or positioned on or next to a GUI.

Moreover, the operating device 5 has a memory unit 11 through which, for example, the position of the cantilever arm 17 may be saved. The memory unit 11 may be a physical memory or a cloud-based memory. For example, using the operating element 6, a saved data record may be selected and retrieved.

In one or some embodiments, the operating device 5 may comprise a control unit 20, which may include processing functionality, such as at least one processor 19 and at least one memory unit 11. Control unit 20 may comprise any type of computing functionality, such as at least one processor 19 (which may comprise a microprocessor, controller, PLA, or the like) and at least one memory unit 11. The memory unit 11 may comprise any type of storage device (e.g., any type of memory). Though the processor 19 and memory unit 11 are depicted as separate elements, they may be part of a single machine, which includes a microprocessor (or other type of controller) and a memory. The processor 19 and memory unit 11 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In one or some embodiments, control unit 20 may be configured to: (1) control the display to output the one or more icons on the GUI; and/or (2) receive the selections (e.g., receive the communication from the touchscreen display indicating that one of the icons has been touched; receive a communication from the one or more mechanical switches of activation). Responsive to the selections, the control unit 20 may perform the following: control the light strip 9 (e.g., control the lighting means, such as controlling the series of lights or controlling the display; control the GUI) and control the front lifting mechanism and/or rear lifting mechanism responsive to input. The control unit 20 may be configured to control the light strip 9 to indicate one or both of: (i) which of the front lifting mechanism or rear lifting mechanism is active; and (ii) a degree of which the active lifting mechanism is lifted.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Work machine

2 Lifting mechanism

3 Front lifting mechanism

4 Rear lifting mechanism

5 Operating device

6 Operating element

7 Selection switch

8 Visualization element

9 Light strip

10 Lighting means

11 Memory unit

12 Hydraulic device

13 Data link

14 Data link

15 Hydraulic device

16 Working range

17 Cantilever arm

18 Axis

19 Processor

20 Control unit

1. An agricultural work machine, comprising:
a front lifting mechanism;
a rear lifting mechanism; and
an operating device including an operating element configured to control operation of the front lifting mechanism and the rear lifting mechanism, at least one visualization element, and at least one selection switch;
wherein the at least one selection switch is configured to receive a selection of at least one of the front lifting mechanism or rear lifting mechanism for active control; and
wherein the at least one visualization element is configured to visually indicate a current lifting position of the one of the front lifting mechanism or the rear lifting mechanism selected for active control.

2. The agricultural work machine of claim 1, wherein the operating element comprises a rotary switch; and
wherein a position of the rotary switch indicates a lifting position for the front lifting mechanism or the rear lifting mechanism selected for active control.

3. The agricultural work machine of claim 2, wherein the rotary switch comprises an incremental rotary switch.

4. The agricultural work machine of claim 2, wherein the rotary switch comprises a continuous rotary switch.

5. The agricultural work machine of claim 2, wherein the rotary switch comprises a rotary pushbutton switch; and
wherein the lifting position is adjusted by rotating and then pressing the rotary pushbutton switch.

6. The agricultural work machine of claim 2, wherein the rotary switch comprises a rotary pushbutton switch; and
wherein the lifting position is saved by pressing the rotary pushbutton switch.

7. The agricultural work machine of claim 1, wherein the at least one visualization element comprises a light strip through which to indicate the current lifting position of the one of the front lifting mechanism or the rear lifting mechanism selected for active control.

8. The agricultural work machine of claim 7, wherein the light strip is indicative of an entire working range from an upper end position to a lower end position divided into a plurality of discrete position steps.

9. The agricultural work machine of claim 8, wherein the light strip comprises a plurality of bar-like or circular arc-like lighting sections, with each of the plurality of bar-like or circular arc-like lighting sections correlated to a respective one of the plurality of discrete position steps.

10. The agricultural work machine of claim 9, wherein the plurality of bar-like or circular arc-like lighting sections comprise multi-color lighting devices; and
wherein the operating device is configured to control a change in the multi-color lighting devices in order to indicate the current lifting position of the one of the front lifting mechanism or the rear lifting mechanism selected for active control.

11. The agricultural work machine of claim 8, wherein the light strip is indicative of a numeric reproduction indicative of a percentage or angle of lifting of the one of the front lifting mechanism or the rear lifting mechanism selected for active control.

12. The agricultural work machine of claim 1, further comprising a memory configured to save the current lifting position of at least one of the front lifting mechanism or the rear lifting mechanism.

13. The agricultural work machine of claim 1, wherein the at least one selection switch comprises a front lifting mechanism selection switch configured to select the front lifting mechanism for active control and a rear lifting mechanism selection switch configured to select the rear lifting mechanism for active control.

14. The agricultural work machine of claim 13, wherein the front lifting mechanism selection switch and the rear lifting mechanism selection switch comprise mechanical switches.

15. The agricultural work machine of claim 13, wherein the front lifting mechanism selection switch and the rear lifting mechanism selection switch comprise icons on a graphical user interface (GUI).

16. The agricultural work machine of claim 13, wherein the operating element comprises a rotary switch configured to receive input indicative of an amount of lifting of the one of the front lifting mechanism or the rear lifting mechanism selected for active control.

17. The agricultural work machine of claim 16, wherein the rotary switch comprises a rotary pushbutton switch;
wherein rotating the rotary pushbutton switch causes the operating device to control the amount of lifting of the one of the front lifting mechanism or the rear lifting mechanism selected for active control the amount of lifting of the one of the front lifting mechanism or the rear lifting mechanism selected for active control; and
wherein pushing the rotary pushbutton switch causes one or both of locking or saving the current lifting position of the one of the front lifting mechanism or the rear lifting mechanism selected for active control.

18. An operating device for controlling operation of both of a front lifting mechanism and a rear lifting mechanism of an agricultural work machine, the operating device comprising:
an operating element configured to control operation of the front lifting mechanism and the rear lifting mechanism;
at least one selection switch configured to receive a selection of at least one of the front lifting mechanism or rear lifting mechanism for active control; and
at least one visualization element configured to visually indicate a current lifting position of the one of the front lifting mechanism or the rear lifting mechanism selected for active control.

19. The operating device of claim 18, wherein the at least one selection switch comprises a front lifting mechanism selection switch configured to select the front lifting mechanism for active control and a rear lifting mechanism selection switch configured to select the rear lifting mechanism for active control.

20. The operating device of claim 18, wherein the operating element comprises a rotary pushbutton switch configured to receive a rotary input indicative of an amount of lifting of the one of the front lifting mechanism or the rear lifting mechanism selected for active control; and
wherein pushing the rotary pushbutton switch causes one or both of locking or saving the current lifting position of the one of the front lifting mechanism or the rear lifting mechanism selected for active control.
